(19) United States
(12) Patent Application Publication
(10) Pub. No.: US 2024/0226930 A9
(43) Pub. Date: Jul. 11, 2024

(54) HAND-HELD SPRAYERS AND NOZZLES FOR SPRAYERS

(71) Applicant: GOJO Industries, Inc., Akron, OH (US)

(72) Inventor: Steven Matsko, Hartville, OH (US)

(21) Appl. No.: 18/493,096

(22) Filed: Oct. 24, 2023

Related U.S. Application Data
(60) Provisional application No. 63/380,635, filed on Oct. 24, 2022.

(51) Int. Cl. B05B 7/12; B05B 7/10

(52) U.S. Cl. CPC B05B 7/12; B05B 7/10

(57) ABSTRACT

Exemplary hand-held sprayers and nozzles for hand-held sprayers are disclosed herein. An exemplary hand-held sprayer includes a container, a pump, and a nozzle. The nozzle is made of a first material, wherein the first material has a hardness of between 20 Shore A and 50 Shore A. The nozzle has a tangential fluid inlet, a conical fluid swirling chamber and a spray orifice. An inner housing and a cap are also included.

### RELATED APPLICATION(S)

The present application claims the benefits of and priority to U.S. Provisional Pat. App. No. 63/380,635 filed on Oct. 24, 2022, which is incorporated by reference herein in its entirety.

### TECHNICAL FIELD

The present invention relates generally to hand-held sprayers and more particularly to hand-held sprayers having improved nozzles.

### BACKGROUND OF THE INVENTION

Hand-held sprayers have sprayer nozzles. The nozzles are typically made from hard materials. The most common materials are brass, nylon, thermoplastics, stainless steel, hardened stainless steel, tungsten carbide, and ceramic. These nozzles tend to clog and need to be cleaned periodically. In addition, the prior art hand-held sprayers typically have screens located upstream of the nozzle, to limit clogging of the nozzle.

### SUMMARY

Exemplary hand-held sprayers and nozzles for hand-held sprayers are disclosed herein. An exemplary hand-held sprayer includes a container, a pump, and a nozzle. The nozzle is made of a first material, wherein the first material has a hardness of between 20 Shore A and 50 Shore A. The nozzle has a tangential fluid inlet, a conical fluid swirling chamber and a spray orifice. An inner housing and a cap are also included.

Another exemplary hand-held sprayer includes a container, a pump and a nozzle. The nozzle comprises a rubber. The nozzle has a tangential fluid inlet, a conical fluid swirling chamber and a spray orifice. The hand-held sprayer also includes an inner housing and a cap.

Another exemplary hand-held sprayer includes a container, a pump and a nozzle. The nozzle has a tangential fluid inlet, a conical fluid swirling chamber and a spray orifice. The spray orifice is configured to expand under pressure to allow particulate to pass through the spray orifice and is configured to return to its original shape when the pressure subsides. The hand-held sprayer includes an inner housing and a cap.

An exemplary nozzle for a hand-held sprayer is made of a first material, wherein the first material has a hardness of between 20 Shore A and 50 Shore A. The nozzle has a tangential fluid inlet, a conical fluid swirling chamber and a spray orifice.

Another exemplary nozzle for a hand-held sprayer comprises a rubber. The nozzle has a tangential fluid inlet, a conical fluid swirling chamber and a spray orifice.

Another exemplary nozzle for a hand-held sprayer includes a tangential fluid inlet, a conical fluid swirling chamber and a spray orifice. The spray orifice is configured to expand under pressure to allow particulate to pass through the spray orifice and is configured to return to its original shape when the pressure subsides.

### BRIEF DESCRIPTION OF THE DRAWINGS

To further clarify various aspects of the present disclosure, a more particular description of inventive concepts will be made by reference to various aspects of the appended drawings. It is appreciated that these drawings depict only typical embodiments of the present disclosure and are therefore not to be considered limiting of the scope of the disclosure. Moreover, while the figures can be drawn to scale for some embodiments, the figures are not necessarily drawn to scale. Features and advantages of the present disclosure will be described and explained with additional specificity and detail through the use of the accompanying drawings in which:

FIG. 1 is a side view of an exemplary embodiment of a hand-held sprayer;

FIG. 2 is a side view of a wand with a folding extension arm in a folded position;

FIG. 3 is a cross-sectional view of the exemplary hand-held sprayer without the container;

FIG. 4 is an enlarged cross-sectional view of the spray tip of the exemplary hand-held sprayer;

FIG. 5 is an exploded prospective view of the spray tip of the exemplary hand-held sprayer;

FIG. 6 is an exploded cross-sectional view of the spray tip of the exemplary hand-held sprayer

FIG. 7 is a cross-sectional view of the exemplary nozzle;

FIG. 8 is a side view of the exemplary nozzle;

FIG. 9 is a prospective view of the exemplary nozzle; and

FIG. 10 is an exploded cross-sectional view of another spray tip for an exemplary hand-held sprayer.

### DETAILED DESCRIPTION

The following description refers to the accompanying drawings, which illustrate specific aspects of the present disclosure.

As described herein, when one or more components are described as being connected, joined, affixed, coupled, attached, or otherwise interconnected, such interconnection may be direct as between the components or may be indirect such as through the use of one or more intermediary components. Also as described herein, reference to a “member,” “component,” or “portion” shall not be limited to a single structural member, component, or element but can include an assembly of components, members, or elements. Also as described herein, the terms “substantially” and “about” are defined as at least close to (and includes) a given value or state (preferably within 10% of, more preferably within 1% of, and most preferably within 0.1% of).

Material described as “compressible” or “flexible” means material with a Shore A hardness of less than 55. The compressible or flexible material is resilient and removing pressure from the compressible or flexible material cause the compressible of flexible material to return to its uncompressed or unflexed shape.

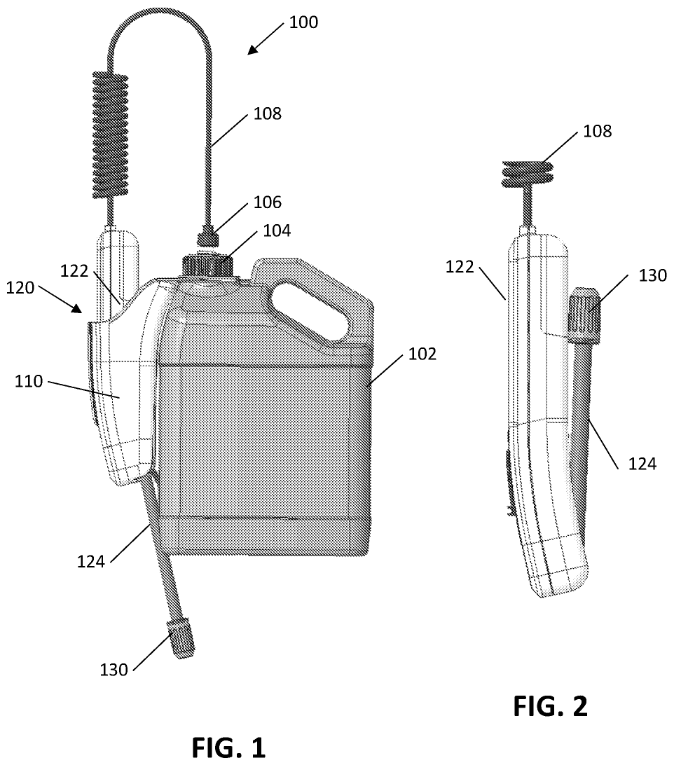

FIG. 1 is an exemplary hand-held sprayer 100. The term hand-held sprayer includes sprayers that are normally carried around by an individual. The hand-sprayers include, for example, backpack sprayers, bulk sprayers, hand-held squeeze sprayers, and the like. The sprayers may be manually powered, or battery powered. Hand-held sprayer 100 includes a container 102. A cap 104, an anti-siphon valve 106, a liquid feed conduit 108, a wand 120. Wand 120 includes a body 122, an extension arm 124 and a spray tip 130. An optional wand holster 110 is secured to container 102. Wand 120 is shown with the extension arm 124 in an extended position in FIG. 1 and in a retracted or folded position in FIG. 2.

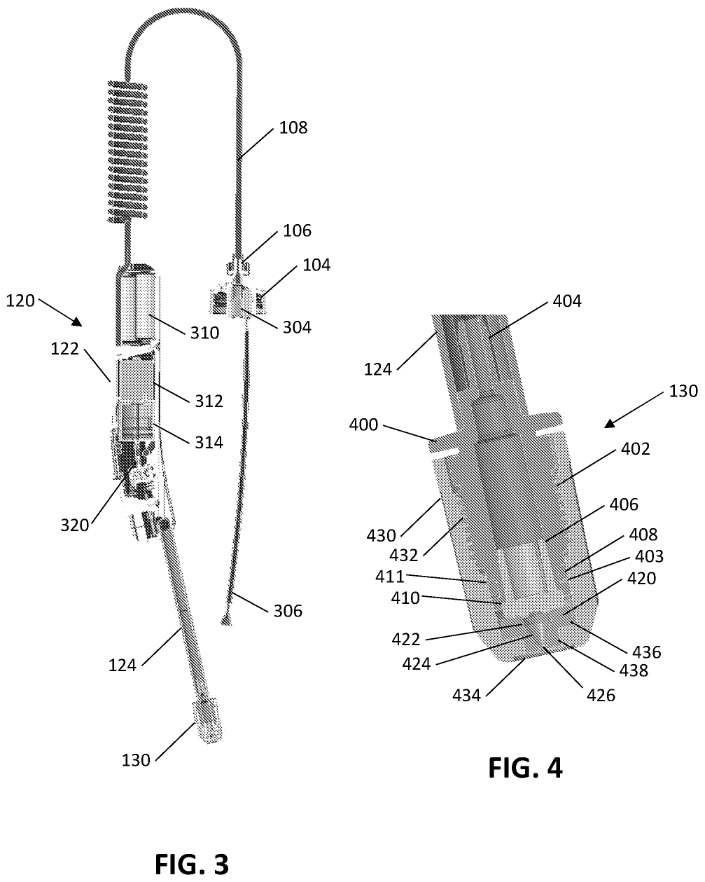

FIG. 3 is a cross-section of sprayer 100 without the container 102 or optional wand holster 110. Located within cap 104 is a density float valve 304. Exemplary density float valves are shown in U.S. Provisional Patent Application Ser. No. 63/275,572, which is titled SPRAYERS AND DENSITY SENSING FLOAT RESTRICTION VALVES FOR SPRAYERS, and which is incorporated herein by reference in its entirety. The density float valve 304 ensures that the fluid being supplied by the hand-held sprayer 100 is the correct fluid. This is particularly useful for disinfect sprayers that are designed to spray alcohol-based disinfectants. If someone fills the container 102 up with a fluid that has a higher water to alcohol ratio then authorized water to alcohol ratio, the float valve 304 will prevent flow. Located above the cap 104 is an anti-siphon valve. The anti-siphon valve prevents fluid from siphoning out of the container when the hand-held sprayer 100 is not in use.

Sprayer 100 is a battery powered sprayer. Wand 120 includes one or more batteries 310. Wand 120 also includes a motor 312 and a pump 314. Pump 314 may be any type of pump, such as, for example, the pumps shown and described in U.S. Pat. No. 10,143,339, titled Sequentially Activated Multi-Diaphragm Foam Pumps, Refill Units and Dispenser Systems, which is incorporated herein by reference in its entirety. The exemplary pumps may be modified to pump liquid only, rather than liquid and air. Wand 120 includes an on button 122 and control circuitry 320.

Spray tip 130 includes a nozzle base 400. Nozzle base 400 includes a barbed connector 404 for connection to wand extension arm 124. Other types of connectors may be used, such as, for example, an adhesive connection, a friction fit connection, a shark-bite connection, a welded connection, or the like. Nozzle base 400 includes a threaded portion 402, and an annular groove 403. A sealing member 408, such as, for example, an o-ring is retained in the annular groove 403 and forms a seal between the nozzle base 400 and the nozzle cap 430. Nozzle base includes a bore 410 for receiving a fluid diverter 406.

Nozzle cap 430 has a threaded portion 432 for connecting to nozzle base 400. Nozzle cap 430 includes a bore having a threaded portion 432 and a smooth portion 411. Smooth portion 411 seals against sealing member 408 to prevent fluid from flowing past. Located at the end of nozzle cap 430 is a base 436 and cylindrical opening 438 therethrough.

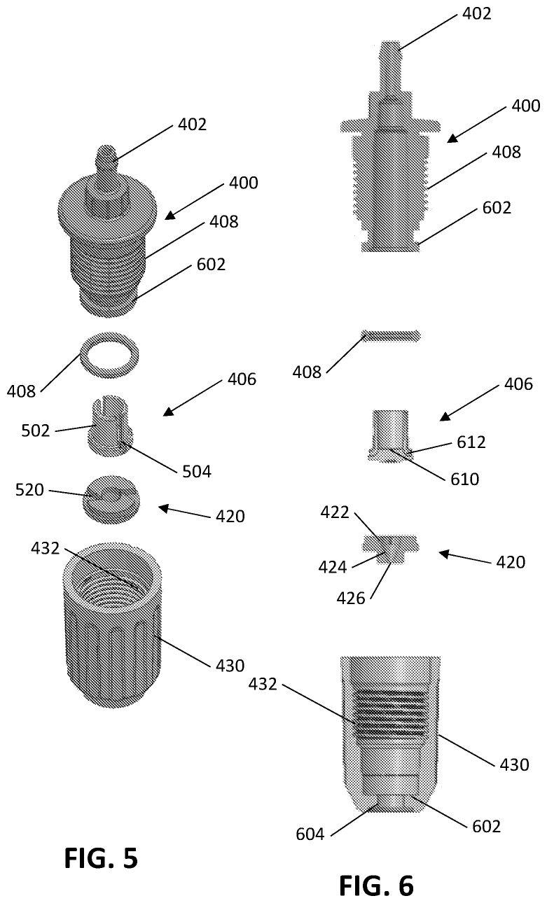

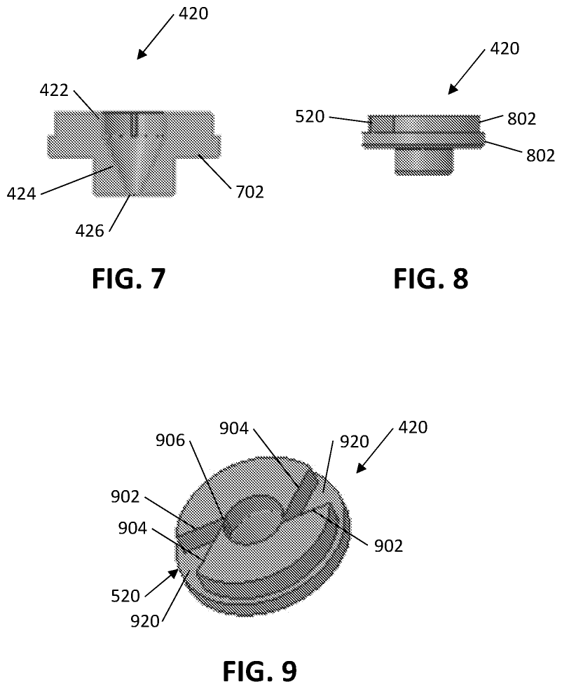

A nozzle 420 is located in the base of nozzle cap 430. The nozzle 420 has a tangential inlet 520 (FIG. 5), a swirling chamber 422, a conical lower portion 424 and an outlet 426.

Nozzle 420 is made of a resilient material that is compressible and flexible. When compressed or flexed, the resilient material returns to its original shape when the compression or bending force is removed. The material has a Shore A hardness of between 20 and 50. The nozzle material may include, for example, one or more of EPDM rubber, Silicone, natural gum rubber, butyl rubber. In contrast, hard plastic is not compressible or flexible as those terms are used herein. Cap 430 and nozzle base 400 are preferably made of molded plastic and are not considered compressible or flexible as the term is used herein.

A durometer harness scale is an international standard for measuring the hardness of rubber and plastic. A durometer rating indicates a material's resistance to surface penetration. Chart I below provides examples of where different types of material on the durometer hardness scale.

Nozzle 420 is flexible and may be compressed. Compressing nozzle 420 changes the fluid flow path through the tangential inlet 520. Compressing nozzle 420 may also change the size of swirling chamber 422. Changing the fluid flow path through the tangential inlet 520 and/or the size of the swirling chamber, adjusts the spray pattern out of the spray tip 130.

In some instances, as the nozzle 420 is compressed, the spray cone widens. In some instances, as the nozzle 420 is compressed, the droplet size gets smaller. In some embodiments, as the nozzle 420 is compressed, the spray distance is reduced but the spray pattern is increased at a given distance.

In addition, compressing the nozzle 420 and changing the flow path may reduce the cross-sectional area of at least a portion of the flow path through the nozzle 420. The reduced cross-sectional area causes the pressure of the fluid at the nozzle 420 to increase.

The threaded nozzle base 400 and threaded nozzle cap 430 are configured to allow for a range of pressures to be applied to the nozzle 420 to compress the nozzle 420. The pressure may range from 0 to 30 pound per square inch (PSI). In some instance, the pressure may range from 0 to 25 PSI. In some instance, the pressure may range from 0 to 20 PSI. In some instance, the pressure may range from 0 to 215 PSI. In some instance, the pressure may range from 0 to 10 PSI. In some instance, the pressure may range from 1 to 30 PSI. In some instance, the pressure may range from 1 to 20 PSI.

Nozzle 420 is flexible, resilient and will return to its original shape if it is stretched or compressed. Nozzle 420 includes a spray orifice 426. Spray orifice 426 is a round orifice. The spray pattern is a solid cone pattern. Spray orifice 426 may be a non-round orifice, such as, for example, a rectangular orifice, an oval orifice, s slit orifice, or the like. Because nozzle 420 is made of a flexible material with a Shore A hardness of less than 55, if particles get trapped in the spray orifice 426 or clogs the spray orifice 426, pressure will build up behind the particles and the spray orifice 426 will expand and allow the particles to flow out of the spray orifice 426. This feature can be used alone or in conjunction with the above-described feature that provides for compressing the nozzle 420 to change the fluid flow path, and thus the spray output.

In some instances, a more stubborn clog may require compressing nozzle 420 to increase the fluid pressure to cause the spray orifice 426 to expand or stretch and allow the particles or clog to flow out.

As shown in FIG. 5, fluid diverter 406 includes a cylindrical body 502 that has a bottom 610 (FIG. 6). A pair of slits 504 extend through the cylindrical body 502. An optional curved surface 612 is located at the bottom of the slits 504. Fluid diverter 406 directs fluid outward and into the tangential fluid inlets 520 of nozzle 420.

As can be seen best in FIGS. 5 and 9, nozzle 420 includes a tangential inlet 520. Tangential inlet 520 includes side walls 902, 904 and a floor base 920. The tangential inlet 520 includes an inner opening 906 that leads into spiraling chamber 422. Inner opening 520 has a rectangular shape. Other shaped inner openings are contemplated. In addition, inner opening 520 extends from the base floor 920 to the top of side walls 902, 904. In some instances, the inner opening 520 does not extend from the base floor 920 to the top of side walls 902, 904. The term tangential inlet as used herein, is an inlet that aids in directing fluid flow into the swirling chamber 422 at an angle that causes the fluid to flow around the swirling chamber 422. The tangential inlet need not have a tangential line with the circular opening.

As shown, side walls 902, 904, if extended would intersect to form an angle. The angle of intersection may be between 0 degrees (i.e. they don't intersect and are parallel) and about 120 degrees. The walls 902, 904 may have an angle of intersection of less than 120 degrees. The walls 902, 904 may have an angle of intersection of less than 100 degrees. The walls 902, 904 may have an angle of intersection of less than 90 degrees. The walls 902, 904 may have an angle of intersection of less than 80 degrees. The walls 902, 904 may have an angle of intersection of less than 70 degrees. The walls 902, 904 may have an angle of intersection of less than 60 degrees. The walls 902, 904 may have an angle of intersection of less than 40 degrees. The walls 902, 904 may have an angle of intersection of less than 30 degrees. The walls 902, 904 may have an angle of intersection of less than 20 degrees. The walls 902, 904 may have an angle of intersection of less than 10 degrees.

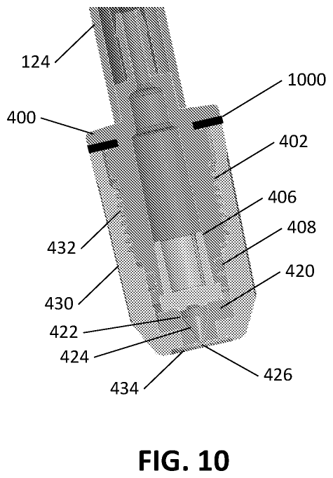

FIG. 10 is a spray tip 1000. Spray tip 1000 is similar to spray tip 130 but spray tip 1000 includes a compression stop 1002. Compression stop 1002 may be built into nozzle base 400 or nozzle cap 430. In this instance compression stop 1002 is a washer. The compression stop limits the amount of travel nozzle cap 430 can have relative nozzle base 400 to limit the maximum pressure put on the nozzle 420.

While various inventive aspects, concepts and features of the disclosures may be described and illustrated herein as embodied in combination in the exemplary embodiments, these various aspects, concepts, and features may be used in many alternative embodiments, either individually or in various combinations and sub-combinations thereof. Unless expressly excluded herein all such combinations and sub-combinations are intended to be within the scope of the present application. Still further, while various alternative embodiments as to the various aspects, concepts, and features of the disclosures—such as alternative materials, structures, configurations, methods, devices, and components, alternatives as to form, fit, and function, and so on—may be described herein, such descriptions are not intended to be a complete or exhaustive list of available alternative embodiments, whether presently known or later developed. Those skilled in the art may readily adopt one or more of the inventive aspects, concepts, or features into additional embodiments and uses within the scope of the present application even if such embodiments are not expressly disclosed herein.

Additionally, even though some features, concepts, or aspects of the disclosures may be described herein as being a preferred arrangement or method, such description is not intended to suggest that such feature is required or necessary unless expressly so stated. Still further, exemplary or representative values and ranges may be included to assist in understanding the present application, however, such values and ranges are not to be construed in a limiting sense and are intended to be critical values or ranges only if so expressly stated.

Moreover, while various aspects, features and concepts may be expressly identified herein as being inventive or forming part of a disclosure, such identification is not intended to be exclusive, but rather there may be inventive aspects, concepts, and features that are fully described herein without being expressly identified as such or as part of a specific disclosure, the disclosures instead being set forth in the appended claims. Descriptions of exemplary methods or processes are not limited to inclusion of all steps as being required in all cases, nor is the order that the steps are presented to be construed as required or necessary unless expressly so stated. The words used in the claims have their full ordinary meanings and are not limited in any way by the description of the embodiments in the specification.

What is claimed is:

1. A hand-held sprayer comprising:
a container;
a pump;
a nozzle base;
a flexible nozzle,
the flexible nozzle made of a first material, wherein the first material has a hardness of between 20 Shore A and 50 Shore A;
the nozzle having
a tangential fluid inlet;
a conical fluid swirling chamber; and
a spray orifice; and
a cap;
wherein the cap secures to the base to retain the flexible nozzle.

2. The hand-held sprayer of claim 1 wherein the nozzle base and the cap are movable with respect to one another and wherein they may be moved with respect to one another to compress or uncompress the flexible nozzle.

3. The hand-held sprayer of claim 2 wherein compressing the flexible nozzle alters the flow path of fluid through the flexible nozzle.

4. The hand-held sprayer of claim 2 wherein the flexible nozzle in an uncompressed state provides a first fluid spray pattern and wherein the flexible nozzle in a compressed state provides a second fluid spray pattern.

5. The hand-held sprayer of claim 1 further comprising a stop to limit inward movement of the cap.

6. The hand-held sprayer of claim 1 further comprising a flow diverter to direct fluid flow to an outer periphery of the flexible nozzle.

7. The hand-held sprayer of claim 1 wherein the flexible nozzle spray orifice is configured to expand to allow particles to pass through and the spray orifice is configured to return to its original position.

8. The hand-held sprayer of claim 1 wherein the flexible nozzle comprises rubber.

9. The hand-held sprayer of claim 8 wherein the rubber is an EPDM rubber.

10. The hand-held sprayer of claim 1 wherein the flexible nozzle has a solid cone spray pattern.

11. The hand-held sprayer of claim 1 wherein the hand-held sprayer has a pressure range at the flexible nozzle of between about 12 and 30 pounds per square inch (PSI).

12. A hand-held sprayer comprising:
a container;
a pump;
a flexible nozzle,
the flexible nozzle comprising a rubber;
the flexible nozzle having
a tangential fluid inlet;
a conical fluid swirling chamber; and
a spray orifice;
an inner housing; and
a cap.

13. The hand-held sprayer of claim 12 wherein the inner housing and the cap are movable with respect to one another and wherein they may be moved with respect to one another to compress or uncompress the nozzle.

14. The hand-held sprayer of claim 12 wherein the rubber has a Shore A hardness of less than 55.

15. The hand-held sprayer of claim 12 wherein the rubber has a Shore A hardness of less than 45.

16. The hand-held sprayer of claim 12 wherein the nozzle in an uncompressed state provides a first fluid spray pattern and wherein the nozzle in a compressed state provides a second fluid spray pattern.

17. A hand-held sprayer comprising:
a container;
a pump;
a nozzle,
the nozzle having
a tangential fluid inlet;
a conical fluid swirling chamber; and
a spray orifice;
wherein the spray orifice is configured to expand under pressure to allow particulate to pass through the spray orifice and is configured to return to its original shape when the pressure subsides;
an inner housing; and
a cap.

18. The hand-held sprayer of claim 17 wherein the inner housing and the cap are movable with respect to one another and wherein they may be moved with respect to one another to compress the nozzle.

19. The hand-held sprayer of claim 17 wherein the rubber has a Shore A hardness of less than 55.

20. The hand-held sprayer of claim 17 wherein the nozzle in an uncompressed state provides a first fluid spray pattern and wherein the nozzle in a compressed state provides a second fluid spray pattern.
